(19) United States
(12) Patent Application Publication
(10) Pub. No.: US 2012/0162078 A1
(43) Pub. Date: Jun. 28, 2012

(54) ADAPTIVE VIRTUAL KEYBOARD FOR HANDHELD DEVICE

(76) Inventors: Bran Ferren, Beverly Hills, CA (US); Morgan Buck, Los Angeles, CA (US)

(21) Appl. No.: 12/979,444

(22) Filed: Dec. 28, 2010

(51) Int. Cl. G06F 3/02

(52) U.S. Cl. 345/168

(57) ABSTRACT

Various embodiments of the invention relate to a configuration of virtual keys that belong to a virtual keyboard displayed on a touchscreen of a hand-held device. The keys are arranged along concentric circles of a virtual wheel so as to be conveniently reached by the user's thumb when the device is held in the user's hand. The sector of keys visible on the touchscreen may be changed by virtually rotating the virtual wheel.

### BACKGROUND

As multi-purpose wireless devices become too small for standard mechanical/electronic keyboards, virtual keyboards are increasingly being used as a primary input device by displaying an arrangement of keys on a touchscreen. The user enters a keystroke by simply touching the screen at the location where the desired key is displayed. Because of the small size and hand-held nature of these devices, many users typically use only their thumbs to enter the data.

However, most of these virtual keyboards arrange the keys in either a rectangular matrix of keys, or in the standard QWERTY format. The linear nature of the rows in such arrangements makes them ill suited for use with the thumbs. Further, the small size of the screen on most of these devices doesn't provide enough space for all the necessary keys to be available at one at one time. Switching from one subset of the keys to another subset can be cumbersome.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a multi-function handheld user device, according to an embodiment of the invention.

FIG. 2 shows a virtual keyboard configured for two-handed operation, according to an embodiment of the invention.

FIG. 3 shows the keys of a keyboard being arranged on a virtual wheel, according to an embodiment of the invention.

FIGS. 4A, 4B, 4C show different sizes of arcs, and the resulting effect on the number of keys displayed, according to an embodiment of the invention.

FIG. 5 shows items displayed on the touchscreen in addition to the basic keyboard, according to an embodiment of the invention.

FIG. 6 shows a flow diagram of a method of changing the displayed sector of the virtual keyboard, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may be implemented as instructions contained in or on a computer-readable medium, which may be read and executed by one or more processors to enable performance of the operations described herein. A computer-readable medium may include any mechanism for storing information in a form readable by one or more computers. For example, a computer-readable medium may include a tangible storage medium, such as but not limited to read only memory (ROM); random access memory (RAM); magnetic disk storage media; optical storage media; a flash memory device, etc.

Various embodiments of the invention relate to a configuration of virtual keys that belong to a virtual keyboard displayed on a touch-screen. Rather than being arranged in straight horizontal rows, the keys may be arranged in arcs that are conveniently reached by the user's thumb(s) when the device is held in the user's hand(s).

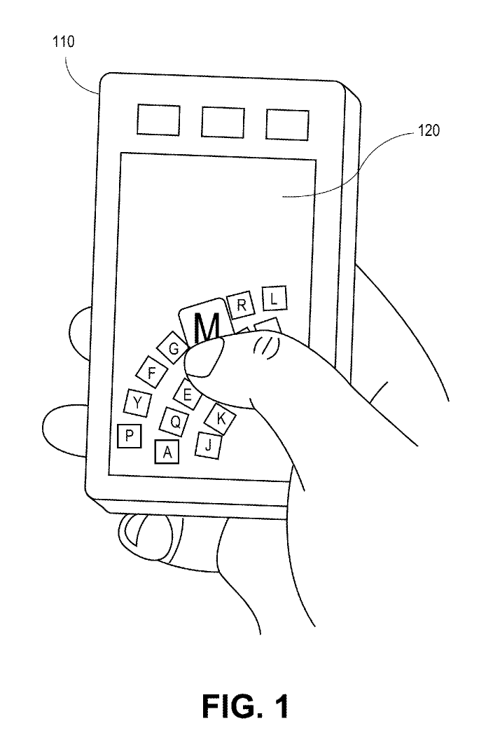

FIG. 1 shows a multi-function handheld user device, according to an embodiment of the invention. The illustrated device 110 is shown with a touchscreen 120 for displaying information to the user and receiving tactile inputs from the user when the user touches the screen at one or more particular locations. Multiple hard buttons are also shown above the display. Other physical buttons, sensors, features, etc. may also be included but are not shown to avoid excessive clutter in the drawing. Within the context of this document, ‘hard’ buttons are so called because they are physical buttons, permanently located in specific areas. But the device may also contain ‘soft’ buttons, each consisting of an icon, or other specific image, on the touch-sensitive display screen, denoted herein as a touchscreen. When the user touches a soft button, the device may sense that touch and perform whatever function is associated with that soft button. The term ‘key’ is used in this document to denote a soft button that represents an individual key on a virtual keyboard shown on the touchscreen. Although not all these keys may be displayed on the touchscreen (and therefore available to be touched) at the same time, they are all capable of being displayed on the touchscreen by changing the portion of the keyboard that is displayed at a particular time.

Although the illustrated device 110 is depicted as having a particular shape, proportion, and appearance, with buttons located in particular locations, this is for example only and the embodiments of the invention may not be limited to this particular physical configuration. For example, in some embodiments various features may be located elsewhere on the same side or on different sides of the device. In some embodiments the overall shape of the device 110 may be different than shown.

Device 110 may also include functionality for wireless communication, for various visual, audio, and physical inputs, and for various visual, audio, and physical outputs that are not specifically described herein. In some embodiments, the device may use this functionality in different ways depending on which mode it is in.

### Virtual Keyboard with Tiered Arcs

FIG. 1 shows a virtual keyboard on the touchscreen display. In a virtual keyboard, each key on the keyboard is implemented as a soft button on the touchscreen. When the user touches a particular key with his/her thumb (or finger, or stylus, or other object), the device 110 may sense that touch, determine where on the screen the touch occurred, determine which key is associated with that location, and interpret this touch as a keystroke of the selected key.

In this example, the keys on the keyboard are arranged in three rows that each follow an arc shape. These rows are positioned for ease of reach by the user's thumb. Because of the configuration of the human thumb, the arcs may not be perfectly circular, but rather each arc might have a variable rate of curvature. For this reason, the term arc may be more accurate when describing the curvature. However, when the terms ‘circle’, ‘concentric’, or ‘wheel’ are used herein, it is understood that they mean approximately circular or concentric or round, but exactness is not required. The arcs described herein are more frequently referred to as ‘tiered’ arcs because each arc has a pivot point, or radial center, that is in approximately the same place, and each arc has a similar shape, with each arc being approximately the same distance from the next adjacent arc throughout the length of those arcs, when measured radially from the pivot point, and even the pivot point for each arc may be in only approximately the same place. Whether or not the term ‘approximate’ is used, it is understood that exactness is not required to comply with the limitations of the claims.

The example of FIG. 1 shows three rows of keys, but other embodiments may have one, two, four, or more rows. The keys are shown the same size in all rows, but in some embodiments, some keys may be larger or smaller than others. For example, the inner row may have smaller keys than the outer row. Not only does this allow more keys to be placed on the inner row, which has less room for keys, but it also recognizes that the user is likely to touch keys on the inner row with the end of his thumb, which presents a smaller touch area than is felt by keys on the outer row, which are touched with the thumb in an extended position. The illustrated example also shows that the three rows are spaced the same distance from each other, but other embodiments may differ. Again, the mechanics and flexibility of the human thumb may determine this spacing.

In some embodiments, the system may provide a finite set of standardized keyboard sizes, each of which has a defined curvature (e.g., extra small, small, medium, large, and extra-large). In some of those embodiments, the user may go through a calibration procedure, and the system may choose the keyboard arrangement that comes closest to the results of the calibration. In others of those embodiments, the user may simply select a preferred keyboard size from among the available choices.

Each key is shown with a somewhat rectangular shape, but the soft keys may be displayed with any convenient shape. In some embodiments, different keys may have different shapes to provide addition information to the user (for example, a square shape for upper case, and a round shape for lower case). Different colors may also be used to denote additional information about that key. Each key is shown labeled with the character it represents. These labels are all shown oriented with respect to the bottom of the device (for easy reading by the user) but other embodiments may orient the label with respect to the radial center of the arcs, or some other reference point. In some embodiments, the displayed character will be shown as upper- or lower-case to indicate whether the upper- or lower-case version of the character is represented by that key.

In some embodiments, whenever a key touch is registered by the device, the symbol represented by the key will be shown in an enlarged version to provide positive feedback to the user, and the position of this enlarged key may be shifted so that it won't be obscured by the user's thumb. In the example of FIG. 1, the user touches the ‘M’ key (which is hidden from view by the user's thumb), and an enlarged version of the ‘M’ key is shown just beyond the user's thumb, temporarily overlaying whatever other keys are located there. Different color, style, shape, etc. may also be used to distinguish this touch indicator from the remainder of the keys.

The example of FIG. 1 shows particular characters assigned to particular key positions, but these assignments are for example only. Other embodiments may assign characters to key positions in any desirable arrangement, such as QWERTY, Dvorak, etc. In some embodiments, key assignments may be programmable by the user.

Because the configuration shown in FIG. 1 is designed for one-handed operation, and the keyboard is therefore limited to the space reachable by a single thumb, there may not be enough space to simultaneously represent all the characters that the user wants to type. To compensate for this, all or a portion of the key positions may be reassigned to represent other characters, and new labels representing the new characters may be produced on the touchscreen for those keys. The position of some or all the keys may also be changed when this happens. This change may be initiated in any convenient manner, such as but not limited to: 1) touching one of the keyboard keys assigned to this function, 2) touching a particular soft key outside the keyboard area, 3) pressing a hard button, 4) dragging the thumb along at least part of an arc, 5) etc.

The keyboard configuration shown in FIG. 1 is designed for right-handed operation by making the rows of keys concentric about the lower right-hand corner. By making the rows of keys concentric about the lower left-hand corner, the device may be suitable for left-handed operation. The illustrated keyboard is also shown configured for vertical operation, i.e., the long side of the touchscreen is vertical. Some embodiments may operate with a horizontal operation, i.e., the long side of the display is horizontal. In some embodiments, the right/left handed configuration and/or the vertical/horizontal operation is selectable by the user. In some embodiments, these configurations may be automatically selected by the device (e.g., sensing gravity to select the vertical/horizontal operation, and/or sensing which part of the display is touched by the user's thumb to select right- or left-handed operation).

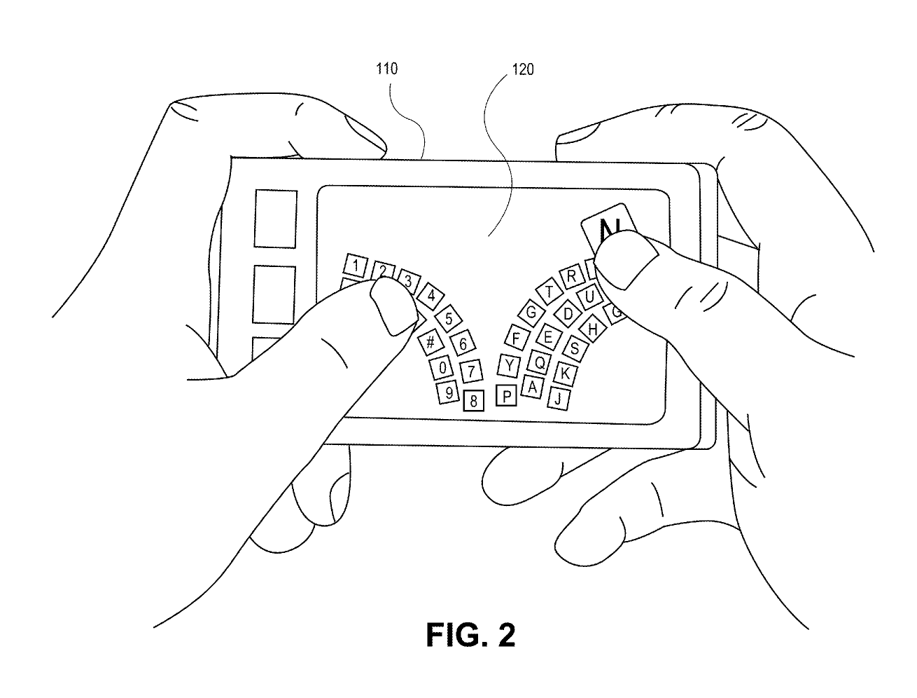

FIG. 2 shows a virtual keyboard configured for two-handed operation, according to an embodiment of the invention. The primary difference between this two-handed operation and the one-handed operation of FIG. 1 is that there are two portions to the virtual keyboard, one configured for operation with the right thumb and the other configured for operation with the left thumb. More keys, and therefore more characters, can be simultaneously displayed with this configuration, as compared with the one-handed configuration of FIG. 1. The two keyboard portions may have the same or a different number of rows, the same or a different number of keys in each row, the same or different spacing, etc. In some embodiments, the assignment of characters to the individual keys may be switched between the left and right areas for the convenience of users that have a left- or right-handed preference. All the same features, techniques, choices, etc. that are available for one-handed operation may also be applied to this two handed operation, and in some embodiments may be applied separately for each portion of the keyboard. In some embodiments the user may manually select either one- or two-handed operation. In some embodiments, the device may automatically select one- or two-handed operation, based on some automatically sensed criteria, such as device orientation or sensing touches on both sides of the touchscreen.

### Virtual Keyboard Wheel

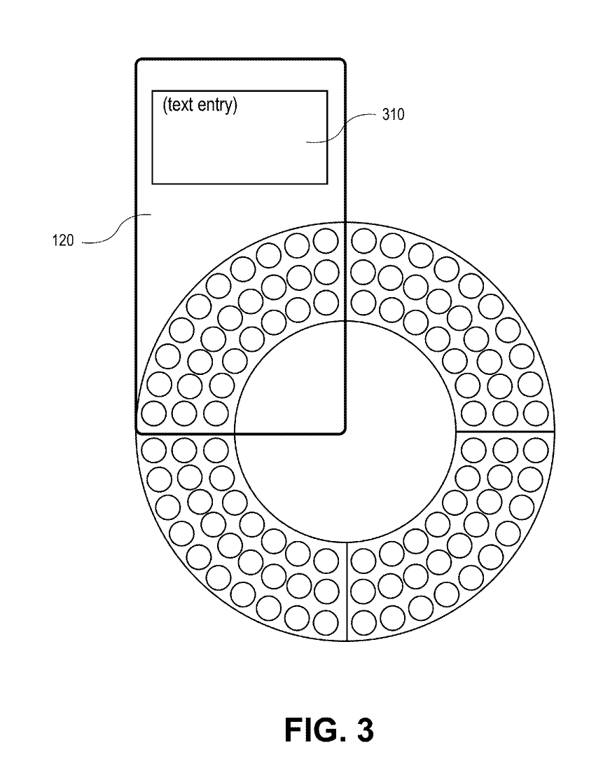

FIG. 3 shows the keys of a keyboard being arranged on a virtual wheel, according to an embodiment of the invention. In some embodiments, the full keyboard may be thought of as being shaped like an approximate wheel, with only the keys in one sector of the wheel visible on the touchscreen 120 at a time. The user may then call up whichever sector he wants displayed. Note: the word ‘sector’, as used in this document, indicates the portion of a circle between two radial lines. The size of a sector may be measured in degrees, fractions of a circle, or other rotation-based parameters. The displayed sector is the sector containing those keys that are visible on the touchscreen at the current time. The offscreen keys on the wheel (those that are not visible on the touchscreen) may also be divided into sectors for reference purposes. These offscreen sectors may or may not be the same size as the onscreen sector, and may or may not be the same size as each other, although having sectors with identical size may be the easiest configuration to implement. In the illustrated embodiment of FIG. 3, each sector represents a 90 degree quadrant of the circle, but other sizes of sector may be used.

The available keys may be distributed among the multiple sectors in any feasible manner. For example, if each sector represents a quadrant, one quadrant might contain keys with letters, another quadrant might contain keys with numbers and punctuation marks, another quadrant might contain keys representing pictures, icons, letterheads, etc., that the user likes to insert into documents, and the fourth quadrant might contain commonly used phrases, names, sentences, paragraphs, etc. In some embodiments, such pictures, icons, letterheads, phrases, names, sentences, paragraphs, etc. may be programmable by the user. Other distributions of keys may be made in any feasible manner. In some instances, a particular key may be contained in more than one sector, if it is deemed useful to do so (e.g., ‘space’, ‘period’, etc.). Of course, the total angular width of all the sectors may add up to more or fewer than the 360 degrees of a circle, since the wheel is a virtual concept and is not constrained to the limitations of an actual physical circle. Also, the visible sector may contain a part of the previous visible sector and a part of a previously invisible sector (for example, if the keyboard wheel is rotated by less than the width of the previous sector).

For simplicity of illustration, the keys are not labeled in FIG. 3, but in actual operation the visible (on-screen) keys may each be labeled with the associated character, and the invisible (off-screen) keys may each have an associated character that will become a label if that key is moved onto the touchscreen. In addition to the keys displayed on the screen, an area 310 for displaying the text being typed is also shown on the touchscreen 120.

For two-handed operation, when two sectors are being displayed (one for each thumb), each of the two visible portions of the keyboard may be visualized as having its own wheel, and this dual sector concept may be handled in various ways. In one embodiment, each thumb may have access to any sector (i.e., any of the sets of available keys), regardless of what sector is being accessed by the other thumb, so it would be possible for both thumbs to be accessing the same set of keys. In another embodiment, a given sector (i.e., a given set of keys) may only be available to one thumb at a time, so if a given sector is being used by one thumb, the other thumb cannot select it. In still another embodiment, some sectors may be available to only one thumb but not the other (for example, letters may be available only to the right thumb, while icons may be available only to the left thumb). Other configurations may also be used.

### Rotating the Wheel

Changing the displayed keys from one sector to another may be triggered in various ways, such as but not limited to:

1) The user may touch a supplementary key outside the basic keyboard area. One supplementary key may be used for clockwise rotation, another supplementary key for counter-clockwise rotation. In the context of this document, ‘rotation’ indicates rotating the wheel and the keys located on the wheel. Alternatively, rotation may be thought of as moving the keys tangentially along the concentric arcs. The effect is the same, regardless of the conceptual framework employed to visualize it. In some embodiments, separate supplementary keys may be used to select each sector directly, without rotating through any intermediate sectors. These supplementary keys may be in the form of either soft keys on the touchscreen, or hard keys or other controls external to the touchscreen.

2) The user may move his thumb across the screen in the desired direction of rotation, and the touchscreen may interpret this gesture as a command to rotate the keyboard. In some embodiments, the speed of this gesture may be a factor. For example, rapid movement may indicate rotating to the next sector, while a slow movement may indicate rotating the keyboard in small increments of less than a full sector. In some embodiments, the length of the gesture may be a factor. For example, a long movement of the thumb may indicate rotating farther than would be indicated by a short movement of the thumb. In some embodiments, the keyboard may rotate in an approximately continuous manner, following the motion of the user's thumb in very small increments.

Regardless of the manner in which the command to rotate is given, some embodiments may visually rotate the keyboard in small increments so that it visually appears to actually rotate. Other embodiments may simply replace the current set of displayed keys with the next desired set of displayed keys, without trying to give the appearance of rotation.

### Positioning the Radial Center of the Arcs

In some embodiments, the location of the radial center of the arcs may be predefined to be at a certain point on the device, such as but not limited to: 1) a corner of the touchscreen, 2) a corner of the device, 3) a predefined distance and direction from one of these points, 4) along the bottom edge of the touchscreen, 5) etc. In other embodiments, the device may determine this center when calibrating the arcs to fit the user's thumb. In still other embodiments, the user may adjust the current location of this center to suit his preference. In various ones of these embodiments, the center may be on the touchscreen, on the device but off the touchscreen, or off the device by a defined direction and distance.

### Adjusting the Size of the Arcs

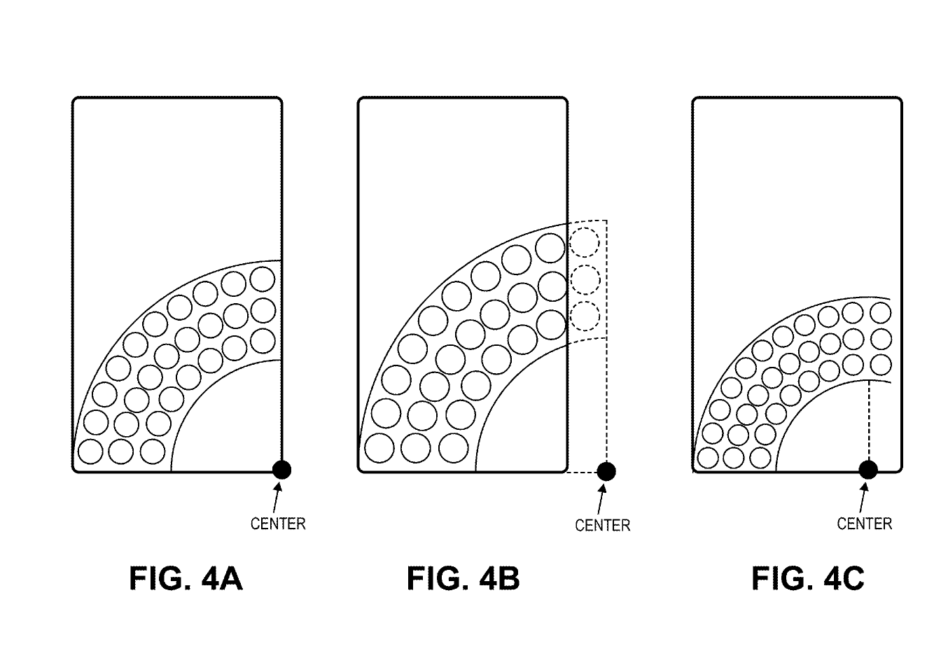

FIGS. 4A, 4B, 4C show different sizes of arcs, and the resulting effect on the number of keys displayed, according to an embodiment of the invention. When the radius of the arcs is adjustable (for example, by calibrating the arcs to the user's thumb, or selecting from multiple size arcs), some choices might cause the outer row of keys to go beyond the far edge of the touchscreen. For example, with a right handed operation in which the radial center is near the lower right corner of the screen, an outer row with too large a radius might extend the outer keys beyond the left edge of the touchscreen (for a vertical format) or beyond the upper edge (for a horizontal format), making them inaccessible, or at least difficult to access or see. The device may avoid this situation by placing constraints on the size and/or location of the displayed sector so that each key on the outer row of the currently visible sector is accessible and/or is fully visible on the touch screen.

FIG. 4A shows a sector size that corresponds to a 90 degree quadrant. This particular illustrated configuration places the radial center at the lower right corner of the touchscreen, and when combined with the indicated arc size, results in the 90 degree sector. FIG. 4B shows larger arcs, in which the radial center is moved to the right (compared to FIG. 4A) to prevent the outer row of keys from being pushed off the left side of the touchscreen. However, this causes a portion of each row in a quadrant-sized sector to be partially or completely pushed off the right side of the touchscreen. In this situation, the displayed sector size may be reduced so that the keys that would be beyond the touchscreen are considered part of another sector that is currently off the screen.

FIG. 4C shows smaller arcs, in which the rows are permitted to extend beyond a 90 degree angle before reaching the right edge of the touchscreen. In this particular illustrated configuration, the radial center is to the left of the lower right corner of the touchscreen, to take advantage of the extra space on the left that results from the smaller arcs and thereby permitting more keys on the right side. In all three examples, the radial center is even with the lower edge of the touchscreen. Of course, the radial center may also be moved up or down from the lower edge, allowing the keyboard to be shortened or extended vertically, similar to the manner in which the examples shorten or extend the keyboard horizontally.

Regardless of whether the arcs cover a radial sector that is less than, equal to, or greater than 90 degrees, some strictly-measured configurations might cause a key to be partially displayed and partially cut off at the edge of the screen. In some embodiments, this may be corrected by removing that key from the display and assigning it to an adjacent sector. In other embodiments, it may be corrected by moving that key tangentially inward so that it is fully displayed, and adjusting the placement of other keys to achieve consistent spacing between keys. In still other embodiments it may be corrected by changing the size of the arcs so that such partial keys are not evident at the end of an arc. These types of adjustments may be made during a custom calibration procedure, or may be made when pre-defined sectors are being created for later selection by the user.

As shown, in some embodiments the maximum radius of the outer row of keys may be limited so that the keys will not extend beyond a predefined distance. Keeping the outer row within the limits of the touchscreen is one example, but some embodiments may restrict the radius even more so as to leave a ‘buffer zone’ between the keys and the edge of the touchscreen. This buffer zone may be chosen for aesthetic reasons, to keep the user from hitting the bezel with his thumb when touching some keys, to provide space on the keyboard that can be used for other purposes, or for any other feasible reason.

### Beyond the Basic Keyboard

Since the rows of keys may follow the curve of an approximately circular arc, if the touchscreen is rectangular (one dimension noticeably longer than the other), that part of the touchscreen that is not occupied by the keyboard may be used for other things. For example, when the touchscreen is in a vertical format, there may be space above the keyboard. If the touchscreen is in a horizontal format, there may be space to the left (for right-handed operation) or to the right (for left-handed operation) of the keyboard. For two handed operation, there may be space near the top between the two visible portions of the keyboard. These spaces may be used for various purposes.

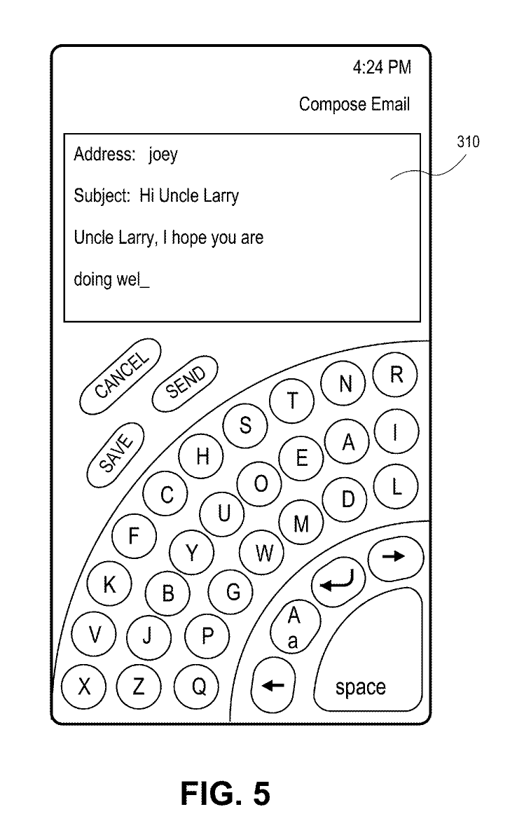

FIG. 5 shows items displayed on the touchscreen in addition to the basic keyboard, according to an embodiment of the invention. One such item is an area 310 to display the text being entered by the user. In some embodiments, the font size of this text may be varied to make the tradeoff between ease of reading (larger font size) and displaying more characters at the same time (smaller font size). In some embodiments, the size of area 310 may be adjusted to accommodate more or fewer displayed characters. In some embodiments, one or both of those adjustments may be made by the user, while in other embodiments one or both of those adjustments may be automatically made by the device.

Another use for space beyond the basic keyboard is to provide more soft keys. Such supplemental soft keys may be placed in any feasible locations, but some embodiments will place some or all of these additional soft keys along one or more arcs, to facilitate ease of reach and consistent operation. FIG. 5 shows some of these keys (e.g., Cancel, Save, and Send keys) outside the outer arc of the basic keyboard, and others of these keys inside the inner arc of the basic keyboard (e.g., Space, upper-lower case toggle, Enter, and right/left keys to rotate the wheel. In a hybrid form of one-handed/two-handed operation, the basic keyboard may be presented for one-handed operation in a horizontal format, while a number of supplemental keys may be presented for use by the opposite hand.

In some embodiments, some or all of these supplemental soft keys may remain on the screen when the basic keyboard is being rotated between sectors. In other embodiments, some or all of these supplemental soft keys may be changed (assigned new functions, removed, added, and/or moved) when the keyboard rotates. In some embodiments, the functions, labels, and/or locations assigned to some or all of these supplemental keys may change for different applications.

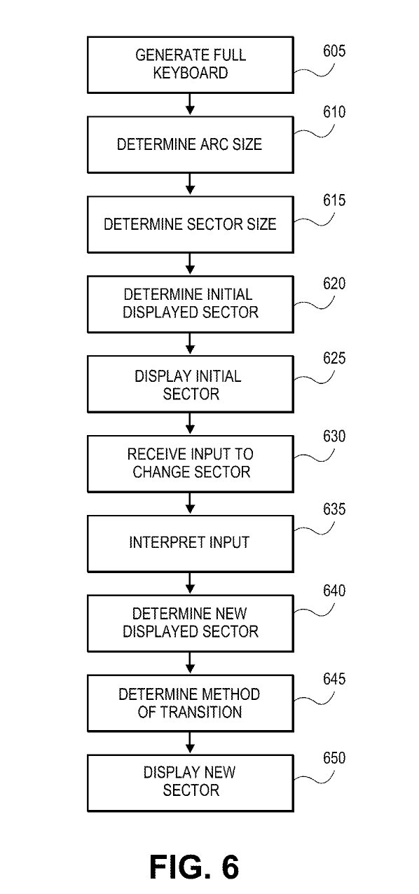

FIG. 6 shows a flow diagram of a method of changing the displayed sector of the virtual keyboard, according to an embodiment of the invention. Although FIG. 6 shows certain actions being performed in a certain order, other embodiments may perform some of these actions in a different order. At 610, the device may generate the full virtual keyboard, as that keyboard is distributed around the virtual wheel. Generating the keyboard may comprise generating keys and positions from scratch, or may simply comprise reading the keyboard information from a database.

At 615, the device may determine the arc size (e.g., radius of the arc) for the various rows of keys. This may be done through a calibration procedure, by selecting from a database of predetermined arc sizes, or through any other feasible means. Once the arc size is determined, the device may determine the sector size. As previously described, the arc size may affect whether the sector size is to be a quadrant, less than a quadrant, or more than a quadrant, and how much more or less than a quadrant. Again, these things may be determined as needed, or retrieved from a database of choices. At 620-625, the device may determine which sector of keys is to be displayed first, and to display that sector on the touchscreen. For example, a default selection might be to initially present the letter keys.

When the user decides to switch to a different sector of keys, at 630 the device may receive an input from the user to do so. As described previously, various types of inputs may be used to indicate this, and the input may have to be interpreted at 635 (e.g., push button, long slow gesture, short fast gesture, etc.). The interpretation of the gesture may then indicate at 640 which sector is to be displayed next. Since there may be multiple methods of switching from one sector to another (instant replacement, incremental rotation, etc.), the particular method to be used may be determined at 645, and that method may be used to produce the new displayed sector at 650.

Other inputs from the keyboard may of course be received at various times, and acted upon by the device, but those processes are beyond the scope of the currently described embodiments.

The foregoing description is intended to be illustrative and not limiting. Variations will occur to those of skill in the art. Those variations are intended to be included in the various embodiments of the invention, which are limited only by the scope of the following claims.

What is claimed is:

1. An apparatus, comprising:
a handheld electronic device having a touchscreen to display a virtual keyboard, wherein the virtual keyboard includes keys arranged in multiple concentric arcs around a virtual wheel, wherein the virtual wheel contains multiple sectors and only one sector of keys are visible on the touchscreen at one time, and wherein the keys visible on the touchscreen are positioned for operation by a user's thumb.

2. The apparatus of claim 1, wherein the device is configured to replace a first sector of keys with a second sector of keys on the touchscreen as a result of an action by the user.

3. The apparatus of claim 2, wherein the action by the user comprises moving the thumb across the touchscreen in a direction of desired rotation of the virtual wheel.

4. The apparatus of claim 2, wherein the action by the user comprises touching a particular soft button on the touchscreen.

5. The apparatus of claim 2, wherein the first and second sectors have no keys in common

6. The apparatus of claim 2, wherein the first and second sectors have some keys in common.

7. The apparatus of claim 2, wherein the first and second sectors each cover one-fourth of a circle.

8. The apparatus of claim 1, wherein the touchscreen includes soft keys positioned inside a smallest of the multiple arcs.

9. The apparatus of claim 1, wherein the touchscreen includes soft keys positioned outside a largest of the multiple arcs.

10. The apparatus of claim 1, wherein the multiple arcs are sized so that all keys in the visible sector on a largest of the multiple arcs are visible on the touchscreen.

11. A method, comprising:
providing a virtual keyboard in a handheld electronic device, with rows of keys arranged in multiple concentric circles;
displaying only one sector of the keyboard at a time on a touchscreen; and
changing the displayed keys from the keys in a first sector to the keys in a second sector in response to an action by a user.

12. The method of claim 11, wherein the said changing comprises rotating the keys tangentially along the concentric circles.

13. The method of claim 12, wherein the action comprises the user moving a thumb across the touchscreen in a direction of intended rotation.

14. The method of claim 11, further comprising creating a supplementary soft key that remains on the touchscreen when changing from the first to second sectors.

15. The method of claim 11, wherein the action comprises the user touching the supplementary soft key.

16. The method of claim 11, wherein the first and second sectors have no keys in common

17. The method of claim 11, wherein the first and second sectors have at least one key in common.

18. The method of claim 11, wherein each sector has a width of one-fourth of a circle.

19. The method of claim 11, wherein the concentric circles are sized so that all keys in the visible sector on a largest of the concentric circles are fully visible on the touchscreen.

20. An article comprising
a computer-readable storage medium that contains instructions, which when executed by one or more processors result in performing operations comprising:
creating a virtual keyboard with rows of keys arranged in multiple concentric circles;
displaying only one sector of the keyboard at a time on a touchscreen; and
changing the displayed keys from the keys in a first sector to the keys in a second sector in response to an action by a user.

21. The article of claim 20, wherein the operation of changing comprises rotating the keys tangentially along the concentric circles.

22. The article of claim 21, wherein the action comprises the user moving a thumb across the touchscreen in a direction of desired rotation.

23. The article of claim 20, wherein the operations further comprise creating a supplementary soft key that remains on the touchscreen when changing from the first to second sectors.

24. The article of claim 20, wherein the action comprises the user touching a particular supplementary key.

25. The article of claim 20, wherein the first and second sectors have no keys in common

26. The article of claim 20, wherein the first and second sectors have at least one key in common.

27. The article of claim 20, wherein each sector has a width of one-fourth of a circle.

28. The article of claim 20, wherein the concentric circles are sized so that all keys in the visible sector on a largest of the concentric circles are visible on the touchscreen.
